(19) United States
(12) Patent Application Publication
(10) Pub. No.: US 2006/0205876 A1
(43) Pub. Date: Sep. 14, 2006

(54) Block copolymers comprising a mixed block derived from isoprene and butadiene and compositions comprising them

(75) Inventors: Cornelis Martinus van Dijk, Armsterdam (NL); Noel Raymond Maurice De Keyzer, Louvain-La-Neuve (BE); George Gumulka, Katy, TX (US)

Correspondence Address: KRATON POLYMERS U.S. LLC, WESTHOLLOW TECHNOLOGY CENTER, 3333 HIGHWAY 6 SOUTH, HOUSTON, TX, 77082, US

(73) Assignee: KRATON Polymers U.S. LLC, Houston, TX (US)

(21) Appl. No.: 11/078,922

(22) Filed: Mar. 11, 2005

(51) Int. Cl. C08L 53/00

(52) U.S. Cl. 525/88

(57) ABSTRACT

Adhesive compositions, comprising a. one or more block copolymers comprising at least two poly(vinyl aromatic) blocks and at least one predominantly poly(conjugated diene) block, b. one or more tackifying resins, and c. optionally one or more plasticizers, characterized in that the block copolymer component (i) comprises at least one block of a randomly copolymerised mixture of isoprene and butadiene in a weight ratio (I:B) in the range of from 99:1 to 80:20, and block copolymers to be used therein.

### FIELD OF THE INVENTION

The present invention relates to block copolymers comprising a mixed block derived from isoprene and butadiene and to compositions comprising said block copolymers. More specifically, the present invention relates to block copolymer compositions such as adhesive compositions, road paving compositions, road marking compositions, compositions for flexible printing plates and the like, which can be composed of easily available and less expensive starting materials. Even more specifically, the invention relates to adhesive compositions, comprising at least two blocks consisting of predominantly poly(vinyl aromatic) blocks and at least one block consisting of a copolymer from mixtures of predominantly isoprene and butadiene, and at least one tackifying resin.

### BACKGROUND OF THE INVENTION

Adhesive compositions based on block copolymers comprising poly(vinyl aromatic) blocks and at least one poly(conjugated diene) block, and more particularly block copolymers comprising poly(styrene) blocks and at least one poly(isoprene) block or poly(butadiene) block (S—I—S or S—B—S) or mixtures of said two block copolymers S—I—S and S—B—S are well known in the art. These compositions are for instance used as PSA (pressure sensitive adhesive) for industrial tapes, packaging tapes and labels, and in multipurpose hot-melt adhesive compositions which may be used to bond or construct articles in the manufacture of disposable sanitary goods such as diapers, feminine care articles, surgical drapes and the like, and in bituminous compositions for road paving and road marking and in compositions for flexographic printing plates. In particular poly(styrene)-poly(isoprene)-poly(styrene block copolymers (S—I—S) and poly(styrene)-poly(butadiene)-poly(styrene block copolymers (S—B—S) are widely used in these adhesive compositions. Both classes of block copolymers give the adhesive composition specific properties, related to the respective inherent characteristics of these block copolymers. For example, the softness of S—I—S makes this polymer the material choice for pressure sensitive applications in tapes and labels. Alternatively, the elevated cohesion of S—B—S makes this material attractive for construction adhesives for disposable soft goods.

When compounded into hot-melt adhesives, S—I—S polymers degrade by a chain scission mechanism; molecular weight is reduced and the cohesive strength of the adhesive is lowered. S—B—S polymers on the other hand tend to degrade by further chemical cross-linking, increasing the cohesive strength of the adhesive, but also increasing the elastic modulus, forming a too hard and non-tacky adhesive. The thermal decomposition of both S—I—S and S—B—S based adhesives can deteriorate the utility of the adhesive product. Accordingly, it would be an advantage to the hot melt adhesive industry if polymers with fewer tendencies to either fall apart (scission) or cross-link would be developed.

In EP-669350 and U.S. Pat. No. 5,583,182, adhesive compositions have been described wherein the styrenic block copolymer is a block copolymer of an S—B—I—S type, an (S—B—I)ₙ—X type or an (S—I—B)ₙ—X type, wherein S represents a polystyrene block, B represents a polybutadiene block and I represents an isoprene block. These copolymers with block copolymer midblocks “B—I” combine some of the characteristics of S—I—S and S—B—S type polymers. However, the process to make blocks of polydienes in the midblock is demanding more complex equipment and requires long polymerisation times. It has been also demonstrated that because of the blocky structure in the midblock, their heat stability performance is still inadequate and that the hot-melt viscosity of formulated adhesives is too elevated for industrial applications compared to respectively S—I—S or S—B—S based formulations.

Several efforts have been made to improve the properties of adhesive compositions in the last decade.

In WO00/14170 an adhesive composition is described based on an elastomeric component comprising (I) an SIS block copolymer and (II) an SBS block copolymer, and on a tackifying component comprising (III) a first hydrocarbon resin compatible with said SIS block copolymer and (IV) a second hydrocarbon resin compatible with said SBS block copolymer. However, the necessity to use two block copolymers (SIS and SBS) as well as two hydrocarbon resins is not a cost effective approach for the manufacture of adhesive compositions, as it requires the adhesive manufacturers to invest deeply in expensive feeding and dosing systems on their extruders. Mixtures of S—B—S and S—I—S type copolymers as earlier tried out, did not provide the required characteristics of modern adhesive compositions either.

From several publications, e.g. DE-2942128A1, JP-1992-0180433 and WO 02/057386A2, the use of block copolymers, comprising poly(vinyl aromatic) blocks and one or more central blocks consisting of polymerised mixtures of isoprene and butadiene, was known. However, in said documents only block copolymers have been actually prepared and tested wherein the weight ratio between isoprene and butadiene was from 70:30 to 30:70, preferably from 60:40 to 40:60 and most preferably about 50:50. Moreover, said block copolymers were taught to be combined in the adhesive compositions with a restricted group of tackifying resins, i.e. those having an aromaticity (in relative percentage of aromatic protons as determined by ¹H-NMR) in the range of from 3 to 18% and preferably from 4 to 14% according to WO 02/057386, page 8, lines 9-27, or with a combination of specific tackifying resins such as in the Example of DE-2942128A1.

It will be appreciated that there is a need for adhesive compositions having characteristics which meet the requirements of modern industry and which can be composed from ingredients selected from a wider variety of available materials and which are less expensive. More particularly, there is a need for block copolymers, the characteristics of which in adhesive compositions remain on the present attractive level and in which the more and more expensive isoprene component has been replaced by the less expensive butadiene.

As result of extensive research end experimentation it has now been found that the attractive properties of e.g. poly(styrene)-poly(isoprene)-poly(styrene) block copolymers in adhesive compositions are maintained, if block copolymers are applied wherein the central midblock(s) of conjugated diene comprises isoprene and butadiene in a weight ratio (I:B) of from 99:1 to 80:20, which block copolymers moreover have appeared to be combined with less expensive tackifying resins selected from a wider group of possible candidates, and preferably with those showing an aromaticity (as determined by ¹H-NMR) of less than 3.

### SUMMARY OF THE INVENTION

The present invention relates to adhesive compositions, comprising
1. one or more block copolymers comprising at least two predominantly poly(vinyl aromatic) blocks and at least one predominantly poly(conjugated diene) block,
2. one or more tackifying resins,
3. optionally one or more plasticizers, characterized in that the block copolymer component (i) comprises at least one block of a randomly copolymerised mixture of isoprene and butadiene in a weight ratio (I:B) in the range of from 99:1 to 80:20.

Moreover, the present invention relates to the hereinbefore specified block copolymers themselves.

Component i

The block copolymers according to the present invention are block copolymers having at least two predominantly poly(vinyl aromatic) blocks and at least one predominantly poly(conjugated diene) block. These block copolymers preferably have a structure represented by the formula
A-C-A (1) or (A-C)ₙ—X (2),
wherein each A independently is a polymer block of an aromatic vinyl compound, C is a mixed polymer block (I/B) of isoprene (I) and butadiene (B) in a weight ratio in the range of from 99:1 to 80:20, preferably from 95:5 to 80:20 and most preferably from 90:10 to 82:18, n is an integer equal to or greater than 2, suitably from 2 to 20, preferably in the range of from 2 to 4, and X is the residue of a coupling agent.

Examples of the aromatic vinyl compound useful in the practice of the present invention include, but are not limited to styrene, alpha-methylstyrene, p-methylstyrene, o-methylstyrene, p-tert.butylstyrene, dimethylstyrene, diphenyl ethylenes such as stilbene, vinylnaphtalene, vinyltoluene (an isomeric mixture of p-methylstyrene and o-methylstyrene), vinylxylene, and mixtures thereof. A preferred monomer is styrene, optionally mixed with one monomer selected from alpha-methylstyrene, p-methylstyrene, o-methylstyrene, diphenyl-ethylene. Most preferred is substantially pure styrene monomer.

As used throughout the specification, the term “predominantly” means that the A polymer block may comprise minor amounts of comonomers other than aromatic vinyl compound, e.g. up to 5 wt % of a copolymerizable monomer such as butadiene and/or isoprene (based on the weight of the total block).

The mixed polymer midblock (C) is made of pure butadiene and pure isoprene as copolymerizing monomers, although it too may contain minor amounts of comonomers, e.g. up to 5 wt % of a copolymerizable monomer such as styrene (based on the weight of the total block). The polymer blocks A preferably have a true molecular weight in the range of from about 9,500 to about 25,000, more preferably from about 10,000 to about 15,000. As used herein, the term “true molecular weight” refers to the molecular weight as determined from the peak of the GPC trace in g/mol.

In the block copolymers according to the present invention, the proportion of bound aromatic vinyl compound is in the range of from about 10 to about 50 wt %, preferably from about 15 to about 45 wt %, based on the total block copolymer. The proportion of bound butadiene is from about 0.9 to about 18% wt %, preferably from about 1.1 to about 15.3% wt % in total. The proportion of bound isoprene is from about 40 to about 89.1 wt %, preferably from about 45 to about 83.3% wt. These amounts of bound monomers (plus copolymerizable monomers, if any) add up to 100 wt %. If the proportion of the bound aromatic vinyl compound is lower than about 10 wt %, holding power is lowered when the resulting block copolymer is used as a base polymer for e.g. pressure sensitive adhesives. On the other hand, any proportion exceeding about 50 wt % generally results in a pressure sensitive adhesive lowered in tackiness.

The block copolymers according to the present invention each preferably have a weight average molecular weight (Mw, expressed in terms of polystyrene) ranging from about 100,000 to about 500,000, preferably from about 150,000 to about 250,000 as determined by Liquid High Performance Size Exclusion (HPSEC) chromatography, using a method analogue to the method described in ASTM D-5296-97), using several substantially pure poly(styrene)calibration standard polymers.

The block copolymers according to the present invention each preferably contain 1,2-vinyl bonds and/or 3,4-vinyl bonds in a proportion of at most about 15 wt %, preferably from about 5 to about 10 wt %, based on the weight of conjugated diene. The block copolymers according to the present invention preferably each have a storage modulus (G′) of from about 1 to about 300 MPa in a viscoelasticity measurement in a temperature range of from 0 to about 50° C., and only one peak on loss tangent (tan δ) attributable to the mixed butadiene/isoprene polymer block at a temperature of −50° C. or below. When a block copolymer having a storage modulus (G′) lower than 1 MPa is used as a base polymer for a pressure sensitive adhesive, then the holding power of the PSA is lowered. On the other hand, any storage modulus exceeding 300 MPa results in a pressure sensitive adhesive lowered in tackiness.

A person skilled in the art will appreciate the difference between polymers having a blocky midblock structure, wherein at least 95 wt % of each monomer is part of a homopolymer block, and polymers having a mixed midblock structure wherein no significant single homopolymer block formation has occurred. For instance, polymers having mixed midblocks may be defined as having average homopolymer block lengths of less than 100 monomer units, preferably less than 50 monomer units, more preferably less than 20 monomer units.

Average homopolymer block length may be determined by various methods. The method used in the present application is based on carbon-13 NMR and was described in detail in WO 02/057386A2, from page 12, line 14 up to page 15, line 12.

The block copolymers according to the present invention can be made e.g. by coupling living diblock copolymers prepared by anionic polymerization with a coupling agent.

As examples of the coupling agent, may be mentioned tin coupling agents; halogenated silicon coupling agents; alkoxysilanes; divinyl aromatic compounds; halogenated alkanes; halogenated aromatic compounds; epoxy compounds such as the diglycidyl ether of bisphenol-A and the like and other coupling agents such as benzoic esters, CO, 2-chloropropene and 1-chloro-1,3-butadiene.

Component (i) may hence comprise a mixture of the coupled polymer according to general formula (1) or (2) and of the intermediate diblock, e.g. in a weight ratio of 100/0 to 40/60 and preferably from 100/0 to 60/40.

The block copolymers according to general formula (1) and (2) can be made by mere adaptation of common processes used for the preparation of S—B—S type block copolymers and/or S—I—S type block copolymers, using a mixture of butadiene/isoprene instead. Of importance in the preparation of the block copolymers according to the present invention is to avoid homopolymer block formation, ensure appropriate B/I ratio, and to produce a polymer block wherein the random midblock has a Tg of −62° C. or less. It may also be beneficial to adapt the process by adding one or both comonomers during the formation of the mixed midblock.

The composition according to the present invention preferably comprises at least one block copolymer selected from the block copolymers (1) and (2) and more preferably of a block copolymer (1).

Component (ii)

The compositions of the present invitation contain one or more tackifying resins. Suitable aromatic hydrocarbon resins as tackifiers are those having a relative percentage of aromaticity (based on aromatic protons relative to the total number of protons in the molecule as determined by ¹H-NMR) of less than 3 and preferably in the range of from 0 to 2.8.

Suitable relative inexpensive tackifying resins may be selected from the type generally referred to as aliphatic or slightly mixed aliphatic/aromatic resins or so-called heat reactive hydrocarbon resins. These hydrocarbon resins have a predominantly aliphatic composition. The streams used to produce these resins contain C-9 components (indene and styrene) and various other C-5 monomers or C-5 dimers.

Examples of suitable relatively inexpensive resins include ESCOREZ™ 2203, ESCOREZ™ 1310 (ExxonMobil), WINGTACK™ EXTRA, WINGTACK™ 95 (Goodyear Chemicals); PICCOTAC™ 1094, and PICCOTAC™ 1095 (Eastman). A preferred tackifier resin is selected from WINGTACK™ EXTRA, ESCOREZ™ 2203 or PICCOTAC™ 1094.

The composition according to the present invention preferably comprises from about 80 to about 250 parts by weight, more preferably from about 100 to about 150 parts by weight of tackifier per 100 parts by weight of block copolymer.

Component (iii)

The composition of the present invention may also contain one or more plasticizers. Suitable plasticizers include plasticizing oils like low aromatic content hydrocarbon oils that are paraffinic or naphthenic in character (carbon aromatic distribution<5%, preferably <2%, more preferably 0% as determined according to DIN 51378). Those products are commercially available from the Royal Dutch Shell Group of companies, such as SHELLFLEX™, CATENEX™, ONDINA™ and EDELEX™ oils. Other oils include KAYDOL™ oil from Witco, or TUFFLO™ oils from Arco. Other plasticizers include compatible liquid tackifying resins such as REGALREZ™ R-1018.

Other plasticizers may also be added, such as olefin oligomers; low molecular weight polymers (<30,000 g/mol) like liquid polybutene, liquid polyisoprene copolymers, liquid styrene/isoprene copolymers or liquid hydrogenated styrene/conjugated diene copolymers; vegetable oils and their derivatives; or paraffin and microcrystalline waxes.

As noted hereinbefore, the composition according to the present invention may, but need not, contain a plasticizer. In the event that the composition does contain a plasticizer, then the composition comprises up to about 100 parts by weight, preferably from about 5 to about 100 parts by weight, more preferably from about 10 to about 50 parts by weight of a plasticizers per 100 parts of block copolymer. Indeed, the, or each block copolymer (i) may be pre-blended with a small amount of plasticizer by the manufacturer of said copolymer. A preferred plasticizer is an EDELEX™ oil such as EDELEX™ 956N.

Other Components (Non-Limitative)

Other rubber components may be incorporated into the adhesive compositions according to the present invention. It is also known in the art that various other components can be added to modify the tack, the odor, the color of the adhesives. Antioxidants and other stabilizing ingredients can also be added to protect the adhesive from degradation induced by heat, light and processing or during storage.

Several types of antioxidants can be used, either primary antioxidants like hindered phenols or secondary antioxidants like phosphite derivatives or blends thereof. Examples of commercially available antioxidants are IRGANOX™ 565 (2.4-bis-(n-octylthio)-6-(4-hydroxy-3,5-di-tertiary-butyl anilino)-1,3,5-triazine) and IRGANOX™ 1010 from Ciba-Geigy (tetrakis-ethylene-(3,5-di-tertiary-butyl-4-hydroxy-hydrocinnamate)methane) and POLYGARD™ HR from Uniroyal (tris-(2,4-di-tertiary-butyl-phenyl)phosphite). Other antioxidants developed to protect the gelling of the polybutadiene segments can also be used, like the SUMILIZER™ GS (2[1-(2-hydroxy-3,5-di-ter-pentylphenyl)ethyl)]4,6-di-tert-pentylphenylacrylate) and SUMILIZER™ T-PD from Sumitomo (pentaerythrythyltetrakis(3-dodecylthiopropionate)); or mixtures thereof.

Preparation of the Composition

No particular limitation is imposed on the preparation process of the adhesive composition of the present invention. Therefore, there may be used any process such as a mechanically mixing process making use of rolls, a Banbury mixer or a Dalton kneader, a hot-melt process characterized in that heating and mixing are conducted by using a melting kettle equipped with a stirrer, like a high shear Z-blade mixer or a single- or twin-screw extruder, or a solvent process in which the compounding components are poured in a suitable solvent and stirred, thereby obtaining an intimate solution of the pressure sensitive adhesive composition.

Use of the Composition

PSA compositions according to the present invention may be applied without using any solvent (e.g., hot-melt) or in the form of their solutions to a base material such as paper or a plastic film by means of a proper coater, thereby producing various kinds of pressure sensitive adhesive tapes or sheets. It may also be used as an adhesive or a sealant without applying to a base material.

Indeed, the block copolymers according to the present invention are excellent in heat stability and hence scarcely undergo a change of melt viscosity with time upon heating and melting them. Therefore, the present adhesion compositions are particularly useful, with good flowability at elevated temperatures, as a hot-melt type pressure sensitive adhesive composition.

During label manufacture, a laminate of a face stock, pressure sensitive adhesive layer and a release liner is passed through an apparatus which converts the laminate into commercially useful labels and label stock. The process involves, amongst others, die-cutting and matrix stripping to leave labels on a release liner.

Moreover, the block copolymer with mixed midblock may find additional uses. For example, these mixed polydiene midblock copolymers may be used in Road Marking Paint (RMP) formulations applied on roads as coating, strips and marking signs to improve the traffic safety or in bituminous road paving compositions. RMP's usually consist of a binder (hydrocarbon resins, polymers, plasticisers) and fillers (pigments, mineral fillers and reflective glass beads). The role of the block copolymer in the binder is to provide strength, flexibility, creep resistance but also low temperature properties. The present block copolymers significantly improve the low temperature properties of such RMP's.

The block copolymers of the present invention can also be applied in compositions for flexographic printing plates, which can be processed by means of visible or UV light.

The properties of the hereinbefore specified block copolymers in the end use compositions, and more in particular the tack properties in adhesive compositions, could certainly not been expected by an average person skilled in the art. Based on the teachings of the hereinbefore discussed prior art a rather linear increase in the tack as function of an increase of the isoprene content in the midblock up to the value of tack of the adhesive composition, composed of pure S—I—S block copolymer, was expected.

It has been surprisingly found now that tack properties similar to those of adhesives derived from pure S—I—S can be achieved, when the isoprene content in the mixed central block of isoprene and butadiene of the applied complete block copolymers is in the range of from about 80% to about 100% and that in the hereinbefore specified range of butadiene contents does not affect the tack properties, while other properties such as adhesion, cohesion and temperature resistance, are also similar to those of adhesives derived from S—I—S block copolymers. Moreover, the block copolymers with mixed central block as specified hereinbefore, have been found to enable to use cheaper aliphatic tackifying hydrocarbon resins from a much wider range, while the compositions maintain the same performance as S—I—S comprising compositions. Further it also allows the use of lower cost block copolymers due to the use of cheaper butadiene instead of isoprene.

The present invention will hereinafter be described more specifically by reference to the following examples and comparative examples. However, this invention is not restricted to these exemplified embodiments only. All designations of “part” or “parts” and “%” as will be used in the following examples, mean part or parts by weight and % respectively unless expressly noted otherwise. The measurements of physical properties were conducted in accordance with the hereinafter described methods.

Test Methods

Standard peel, tack, and cohesion tests were carried out on these formulations as described in the Test method manual for Pressure Sensitive Tapes from the Pressure Sensitive Tape Council (PSTC), the standard FINAT test method for Pressure sensitive materials, the AFERA test methods for Pressure Sensitive Adhesive Tapes and the ASTM related methods. The testing surface used was chromed stainless steel plates (No. 304)(“ss”) as recommended by the FINAT
Loop tack (LT) was determined using PSTC-5 and FTM 9 loop tack method. High numbers LT indicate aggressive tack. Results are expressed in Newton/25 mm (N/25 mm).
Peel Adhesion (PA) was determined by Pressure Sensitive Tape Council Method No. 1 and ASTM D3330-83. Large numbers indicate high strength when peeling a test tape from a steel substrate. Results are expressed in N/25 mm.
Holding Power (HP) is the time required to pull a standard area (1.3×1.3 cm) of tape from a standard test surface (steel=ss,) under a standard load (1 kg, 2 or 5 kg), in shear at 2° (Pressure Sensitive Tape Council Method No. 7; ASTMD-3654-82). Long times indicate high adhesive strength. Results are expressed in hours (h) or minutes (min). This test can be carried out at room temperature (about 23° C.) or at a more elevated temperature, depending on the test.
The SAFT (shear adhesion failure temperature) was measured by 2.5×2.5 cm Mylar to chromed ss plates with a 1 kg weight. The samples are placed in an oven and the temperature is raised by 22° C./minute. SAFT measures the temperature at which the lap shear assembly fails.
Glass transition temperatures Tg have been determined by Differential Scanning calorimetry with a temperature sweep of 40° C./min. The Tg is measured at the onset of the transition.
Polystyrene content was determined by ¹H NMR.
Average homopolymer block lengths have been determined by ¹³C NMR using the method described in WO 02/57386, from page 12, line 14 to page 15, line 12. ¹³C NMR spectra of polymer samples were obtained with a Bruker AMX-500 FT spectrometer operating at 125 MHz. Quantitative proton-decoupled spectra were recorded with a 90° ¹³C excitation pulse and a repetition rate of 10 s. 10% (w/w) of polymer solutions in CDCl₃ were used. To improve the relaxation time 0.1 mol/l chromium acetylacetonate was added. The applied line broadening was 2 Hz. The spectra were referenced such that the aliphatic carbons of trans-polybutadiene are at 31.9 ppm.

### EXAMPLES

Synthesis of the Block Copolymers A and B and Comparative Examples (C-I to C-V)

Cyclohexane, styrene, butadiene and isoprene were purified by activated aluminumoxide and stored at 4° C. under a nitrogen atmosphere. Prior to synthesis, a monomer mixture of butadiene and isoprene (at a weight/weight ratio given in Table 1) was prepared and stored under nitrogen at 4° C. This mixture was used as such.

An autoclave, equipped with a helical stirrer was charged with cyclohexane and the content was heated to 50 to 60° C. As initiator, sec-BuLi, was dosed immediately followed by styrene monomer, which was allowed to polymerize to completion. The reaction temperature was increased to 70° C., at which temperature a butadiene/isoprene monomer mixture (B/I) was dosed and reacted. The resulting diblock was coupled with a difunctional coupling agent in case of polymer A. In case of polymer B, the diblock was reacted with a further dose of styrene. In both cases, this was followed by addition of ethanol as terminator. The reaction mixture was cooled to 40° C., transported to a blending vessel and a stabilization package was added (comprising IRGANOX™ 565 and tris(nonylphenol)phosphite 0.08/0.35 phr as a cyclohexane solution) and stirred at RT. Dry rubber was obtained by steam coagulation finishing, followed by drying in an oven.

The polymers were analyzed by Liquid High Performance Size Exclusion Chromatography (HPSEC) according to the method described ASTM D 5296-97. The results of the HPSEC analysis and other relevant parameters are in Table 1.

Comparative Example C-III is the same polymer as Example D in WO 02/057386. The other polymers C-I, C-II, C-IV and C-V have been made by a process similar to that used for Polymer C-III, using butadiene/isoprene ratios outside of that claimed in the present invention.

Further components used in the examples are listed in Table 2.

TABLE 1

| | Polymer | | | | | | |
|---|---|---|---|---|---|---|---|
| | A | B | C I | C II | C III | C IV | C V |
| Mw polystyrene | 10.8 | 11.3 | 11.5 | 11.5 | 10.8 | 11 | 10.9 |
| *10³ | | | | | | | |
| Total Mw *10³ | 166 | 180 | 201 | 183 | 227 | 175 | 163 |
| Coupling | 81 | 100 | 79 | 74 | 85 | 72.5 | 77.6 |
| efficiency % | | | | | | | |
| Polystyrene | 19.6 | 18.6 | 17.2 | 20 | 14.8 | 19 | 19.6 |
| content % | | | | | | | |
| Bd/lp ratio wt/wt | 14/86 | 5/95 | 50/50 | 40/60 | 30/70 | 31/69 | 22/78 |
| 1,2 Bd | 8 | 8 | 8 | 8 | 8 | 8 | 8 |
| 1,2-3,4 lp | 5 | 5 | 5 | 5 | 5 | 5 | 5 |

TABLE 2

| D-1160 | KRATON ® D1160 NS is a clear linear |
|---|---|
| | poly(styrene-isoprene-styrene) block copolymer with |
| | 19% polystyrene content, a total molecular weight |
| | of about 180,000. |
| PICCOTAC ™ | a C₅ aliphatic hydrocarbon resin with a softening |
| 1095 | point of 95° C., an aromaticity of 0%, manufactured |
| | by EASTMAN CHEM. CO. |
| ESCOREZ ™ | a modified resin with a softening point of 93° C., |
| 2203 | an aromaticity of 2.2%, manufactured by |
| | EXXON-MOBIL Chemicals. |
| WINGTACK ™ | a modified resin with a softening point of 97°, |
| Extra | an aromaticity of 2.6% manufactured by |
| | GOODYEAR |
| EDELEX ™ | a naphtenic oil from DEUTSCHE SHELL A.G. |
| 965N | |
| IRGANOX ™ | an anti-oxidant from CIBA-GEIGY A.G. |
| 1010 | |

### Example 1

Table 3 shows the respective composition and test results of various adhesive formulations each comprising 100 parts by weight of block copolymer, i.e. a block copolymer according to the present invention (Polymer A and Polymer B) and comparative block copolymers (C-I to C-V, as described in the examples of WO 02/057386 and KRATON® D-1160), 110 parts by weight of an hydrocarbon resin and 15 part by weight of an oil and 3 parts by weight of an antioxidant.

The tested adhesive compositions have been solvent coated at 22 g/sm dry on 36 microns PET film. Prior to testing, all the samples have been stored for 24 hours in a conditioned room at 23° C.-50% relative humidity.

TABLE 3

| | | 100/110/15 | | | |
|---|---|---|---|---|---|
| | Isoprene/ | LT | PA | HP ss 2 kg | SAFT |
| | Butadiene w % | N/25 mm | N/25 mm | hours | 0.5 kg |
| ESCOREZ ™ 2203 | | | | | |
| Polymer A | 86/14 | 15 | 16 | >300 | 108 |
| Polymer B | 95/5 | 14 | 16 | >300 | 110 |
| C-I | 50/50 | 0 | 2 | — | — |
| C-II | 60/40 | 0 | 2 | — | — |
| C III | 70/30 | 9 | 16 | >300 | 103 |
| C V | 78/22 | 14 | 18 | >300 | 103 |
| D-1160 | 100/0 | 15 | 18 | >300 | 110 |
| PICCOTAC ™ 1095 | | | | | |
| Polymer A | 86/14 | 12 | 17 | >100 | 114 |
| Polymer B | 95/5 | 12 | 17 | >100 | 113 |
| C II | 60/40 | 0 | 8 | — | — |
| ESCOREZ ™ 2203 | | | | | |
| Polymer A | 86/14 | | | | |
| Polymer B | 95/5 | | | | |
| C-I | 50/50 | | | | |
| C-II | 60/40 | | | | |
| C III | 70/30 | | | | |
| C V | 78/22 | | | | |
| D-1160 | 100/0 | | | | |
| PICCOTAC ™ 1095 | | | | | |
| Polymer A | 86/14 | | | | |
| Polymer B | 95/5 | | | | |
| C II | 60/40 | | | | |
| C V | 78/22 | | | | |
| D-1160 | 100/0 | | | | |
| WINGTACK ™ Extra | | | | | |
| Polymer A | 86/14 | | | | |
| Polymer B | 95/5 | | | | |
| C II | 60/40 | | | | |
| C IV | 69/31 | | | | |
| C V | 78/22 | | | | |
| D-1160 | 100/0 | | | | |
| C V | 78/22 | 9 | 19 | >100 | 107 |
| D-1160 | 100/0 | 14 | 19 | >100 | 111 |
| Polymer A | 86/14 | 20 | 18.9 | >100 | 107 |
| Polymer B | 95/5 | 20 | 18.4 | >100 | 112 |
| C II | 60/40 | 0 | 10.4 | >100 | 110 |
| C IV | 69/31 | 14.5 | 19.6 | >100 | 106 |
| C V | 78/22 | 20.5 | 16.5 | >100 | 107 |
| D-1160 | 100/0 | 22 | 19.6 | >100 | 110 |

It will be appreciated from Table 3 that the adhesive properties and in particular the tack (LT is Loop Tack), when using the block copolymers of the present invention, are close to those, when using pure S—I—S block copolymer (KRATON® D-1160), and that these adhesive properties deteriorate, when the I/B ratio in the applied block copolymers are outside the claimed range (>20 wt %).

1. An adhesive composition, comprising
a. one or more block copolymers comprising at least two predominantly poly(vinyl aromatic) blocks and at least one predominantly poly(conjugated diene) block,
b. one or more tackifying resins, and
c. optionally one or more plasticizers,
characterized in that the block copolymer component (i) comprises at least one block of a randomly copolymerised mixture of isoprene and butadiene in a weight ratio (I:B) in the range of from 99:1 to 80:20.

2. The adhesive composition of claim 1, wherein the randomly polymerised mixture of isoprene and butadiene has a weight ratio in the range of from 95:5 to 80:20.

3. The adhesive composition of claim 2, wherein the randomly polymerised mixture of isoprene and butadiene has a weight ratio in the range of from 95:10 to 82:18.

4. The adhesive composition of claim 1, wherein the block copolymer component (i) comprises blocks A, having a true molecular weight in the range of from 9,500 to 25,000.

5. The adhesive composition of claim 1, wherein the block copolymer component (i) has a poly(vinyl aromatic) content of from 15 to 45 wt %.

6. The adhesive composition of claim 1, wherein the block copolymers are of the formula
A-C-A (1) or (A-C)ₙ—X (2),
wherein each A independently is a polymer block of an aromatic vinyl compound, and C is a mixed polymer block (I/B) of isoprene (I) and butadiene (B).

7. The adhesive composition of claim 1, wherein each block copolymer contains 1,2-vinyl bonds and/or 3,4-vinyl bonds in a proportion of at most 15 wt %.

8. The adhesive composition of claim 7, wherein component (i) further comprises an intermediate diblock in a weight ratio of coupled polymer of formula (1) or (2) to diblock of 100/0 to 40/60.

9. The adhesive composition of claim 7, wherein the midblock has a Tg of −62° C. or lower.

10. Tapes, labels and sanitary articles obtainable by application of the adhesive composition of claim 1.

11. A block copolymer, characterized in that it comprises at least two poly(vinyl aromatic) blocks and at least one block of a randomly copolymerized mixture of isoprene and butadiene in a weight ratio (I:B) in the range of from 99:1 to 80:20.

12. The block copolymer of claim 11, wherein the randomly copolymerized mixture of isoprene and butadiene has a weight ratio of from 95:5 to 80:20.

13. The block copolymer of claim 11, wherein the blocks A have a true molecular weight in the range of from 9,500 to 25,000.

14. The block copolymer of claim 12, wherein the blocks A have a true molecular weight in the range of from 9,500 to 25,000.

15. The block copolymer of claim 11, having a poly(vinyl aromatic) content in the range of from 15 to 45 wt %.

16. The block copolymer of claims 12, having a poly(vinyl aromatic) content in the range of from 15 to 45 wt %.

17. The block copolymer of claim 13, having a poly(vinyl aromatic) content in the range of from 15 to 45 wt %.

18. The block copolymer of claim 11 wherein the block copolymers are of the formula
A-C-A (1) or (A-C)ₙ—X (2),
wherein each A independently is a polymer block of an aromatic vinyl compound, and C is a mixed polymer block (I/B) of isoprene (I) and butadiene (B).

19. The block copolymer of claim 11, wherein each block copolymer contains 1,2-vinyl bonds and/or 3,4-vinyl bonds in a proportion of at most 15 wt %.

20. The block copolymer of claim 18, wherein the midblock has a Tg of −2° C. or less.
